(19) United States
(12) Patent Application Publication
(10) Pub. No.: US 2026/0084260 A1
(43) Pub. Date: Mar. 26, 2026

(54) APPARATUS AND METHOD FOR CONTINUOUS MILLING AND MIXING

(71) Applicant: SAUDI ARABIAN OIL COMPANY, Dhahran (SA)

(72) Inventors: Guanghui ZHU, Dhahran (SA); Khaled SALOOMI, Dhahran (SA)

(73) Assignee: SAUDI ARABIAN OIL COMPANY, Dhahran (SA)

(21) Appl. No.: 18/895,078

(22) Filed: Sep. 24, 2024

(51) Int. Cl. B24B 31/14; B01F 31/86

(52) U.S. Cl. CPC B24B 31/14; B01F 31/86

(57) ABSTRACT

An apparatus includes a milling chamber, one or more hoppers arranged to continuously discharge material into the milling chamber, a plurality of grinding balls disposed in the milling chamber, a vibration generating device operable to agitate the grinding balls and thereby mill material received within the milling chamber from the one or more hoppers, and a collection chamber positioned to receive material continuously discharged from the milling chamber.

### FIELD OF THE DISCLOSURE

The present disclosure relates generally to the preparation of catalyst materials or extrudates and, more particularly, to methods and apparatuses for continuously mixing and milling materials.

### BACKGROUND OF THE DISCLOSURE

Catalyst extrudate may be prepared from several solid ingredients, and the conventional methods and apparatuses for preparing the catalyst from such solid ingredients involves mixing and milling the solid ingredients to break down the large particle aggregates in order to thereby generate a uniform mixture of particles of the different materials. By breaking down the large particles into fine particulate matter, and then mixing such fine particulate matter, interaction between the different materials is maximized, which helps to improve performance of the resulting catalyst. However, when utilizing certain types of materials in the catalyst preparation, care must be taken to avoid damaging the crystalline structure of one or more of the materials, and milling may therefore not be suitable with certain ingredient materials.

For example, zeolite and amorphous silica alumina (ASA) are ingredients utilizable in catalyst preparation, but care must be taken to avoid damaging the crystalline structure of the zeolite. This is because the zeolite needs to maintain its crystallinity to provide the adequate acidity for cracking. Thus, while care must be taken to avoid milling of the zeolite so that it maintains its crystallinity, it nevertheless needs to be well mixed with the milled alumina and ASA. Then, the resulting mixture is kneaded (with liquid addition) and extruded.

To avoid damaging crystalline structure of one or more of the materials during catalyst preparation, existing catalyst preparation techniques that include mixing and milling steps are performed in batches, sometimes using a rotary drums, after which the materials are transferred to the muller to be mixed with the liquid solution. This batched process, however, is time consuming and the mixing and milling quality performed via the rotary drum is not consistently of high quality.

Accordingly, methods and systems are desired for efficiently producing catalyst without damaging the desired properties of the ingredients.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a continuous mixing and milling apparatus includes a milling chamber, one or more hoppers arranged to discharge unprocessed ingredients into the milling chamber, a plurality of grinding balls disposed in the milling chamber, a vibration generating device operable to agitate the grinding balls and thereby grind the unprocessed ingredients received within the milling chamber into processed ingredients, and a collection chamber positioned to receive the processed ingredients discharged from the milling chamber.

In another embodiment, a continuous mixing and milling apparatus includes a first stage and a second stage. The first stage includes a first milling chamber, one or more first hoppers arranged to continuously discharge unprocessed ingredients into the milling chamber, a plurality of grinding balls disposed in the milling chamber, a vibration generating device operable to agitate the grinding balls and thereby grind the unprocessed ingredients and generate processed ingredients, a first collection chamber positioned to receive the processed ingredients discharged from the milling chamber, and an outlet in communication with the first collection chamber. The second stage includes a second mixing chamber in communication with the outlet for receiving processed ingredients from the first collection chamber, and a second collection chamber positioned to receive processed ingredients discharged from the second mixing chamber.

In a further embodiment, a method of continuously mixing and milling a plurality of ingredients includes introducing a first unprocessed ingredient from a hopper into a milling chamber, agitating grinding balls via vibration to thereby grind the first unprocessed ingredient within the milling chamber and thereby generate a first processed ingredient, and continuously introducing the first unprocessed ingredient into the milling chamber so that the first processed ingredient overflows the milling chamber and spills into a collection chamber positioned to receive the first processed ingredient overflowing the milling chamber.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic cross-sectional side view of a milling and mixing apparatus, according to one or more embodiments of the present disclosure.

FIG. 2 a schematic cross-sectional side view of the milling and mixing apparatus of FIG. 1 when connected to additional equipment utilized in catalyst preparation, according to one or more embodiments.

FIG. 3 a schematic cross-sectional side view of an alternate milling and mixing apparatus, according to one or more embodiments.

FIG. 4 a schematic cross-sectional side view of another alternate milling and mixing apparatus, according to one or more embodiments.

FIG. 5 schematic cross-sectional side view of a multi-stage milling and mixing system, according to one or more embodiments.

FIG. 6 is a schematic flowchart of an example method for continuously mixing and milling ingredients, according to one or more embodiments of the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to an apparatus for continuously mixing and milling ingredients (or materials) utilized in catalyst preparation. Ingredients may be input into the apparatus via one or more hoppers, which store unprocessed ingredients, and one or more hoppers is/are positioned to allow such unprocessed ingredient(s) to flow into a milling chamber. The unprocessed ingredient(s) entering the milling chamber may be milled or ground via milling media that is agitated with vibration, such that the unprocessed ingredients are milled/ground in the milling chamber and thereby converted into processed ingredients. The hoppers continuously introduce the unprocessed ingredients into the milling chamber, where they are continuously milled within the milling chamber, such that processed ingredients overflow out of the milling chamber, downward through the apparatus into a collection chamber. Additional hoppers may be provided that introduce additional (or different) unprocessed ingredients directly into the collection chamber or directly into a mixing chamber that is positioned upstream of the collection chamber, such that the additional (or different) unprocessed ingredients supplied by the additional hoppers bypass the milling chamber. Having ingredients bypass the milling chamber allows the apparatus to protect certain ingredients from processing (e.g., grinding/milling) that may otherwise damage the ingredients, which could impact the quality of the resulting catalyst.

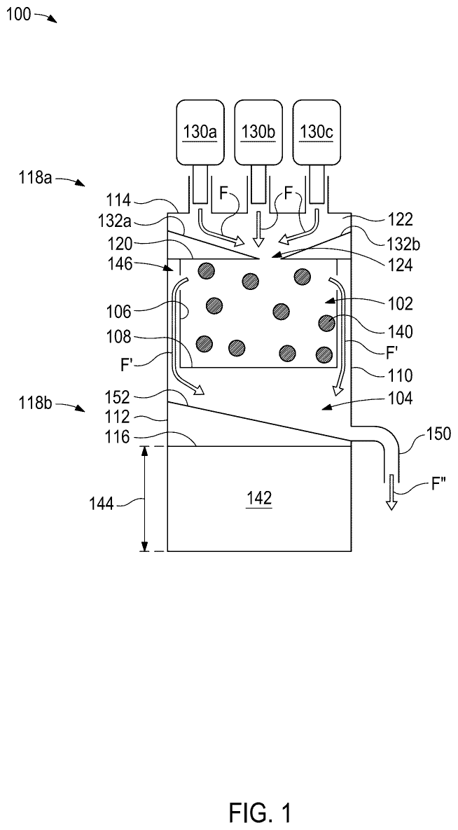

FIG. 1 is a schematic cross-sectional side view of an example milling and mixing apparatus 100, according to one or more embodiments of the present disclosure. The milling and mixing apparatus 100 (hereinafter, the “apparatus 100”) is utilizable in the preparation of catalyst materials.

In the illustrated embodiment, the apparatus 100 includes a milling chamber 102 and a collection chamber 104. As shown, the milling chamber 102 is separate from the collection chamber 104, and the collection chamber 104 is positioned to receive material continuously discharged from the milling chamber 102. In the illustrated embodiment, the milling chamber 102 is disposed within (or inside of) the collection chamber 104. Also, as further detailed below, the milling chamber 102 is (at least partially) defined by sidewalls 106 and lower wall 108.

Also in the illustrated embodiment, the apparatus 100 includes a housing 110 within which the milling and collection chambers 102, 104 are provided. The housing 110 includes sidewalls 112, an upper wall 114, and a lower wall 116 opposite the upper wall 114, with the upper and lower walls 114, 116 provided at upper and lower ends 118a, b of the sidewalls 112. As shown, the collection chamber 104 is an interior compartment within the housing 110, and the milling chamber 102 is suspended within the interior compartment of the housing 110 that defines the collection chamber 104. In some embodiments, the housing 110 includes a lid portion and a base portion, wherein the milling chamber 102 is suspended from the lid portion, and the lid portion is removable from the base portion so that the milling chamber 102 may be removed/extracted from the base portion of the housing 110 and, in embodiments, from the collection chamber 104 thereof. Removal of the lid portion and the milling chamber 102 attached thereto may thereby expose the interior of the collection chamber 104.

In the illustrated embodiment, an inner plate 120 is arranged within the housing 110, with an introduction chamber 122 being disposed above the inner plate 120 (i.e., the introduction chamber 122 is defined between the upper wall 114, the inner plate 120 and upper portions of the sidewalls 112). Thus, in the illustrated embodiment, the inner plate 120 forms the upper boundary of the collection chamber 104, such that the collection chamber 104 is disposed beneath the inner plate 120 and beneath the introduction chamber 122. Also, as shown, the inner plate 120 includes an opening 124 and the milling chamber 104 is attached to and suspended from a lower surface of the inner plate 120 with the opening 124 being in communication with an interior of the milling chamber 102, such that the milling chamber 102 extends into the collection chamber 104 and such that the milling chamber 102 is also disposed beneath the inner plate 120 and beneath the introduction chamber 122. Accordingly, in the illustrated embodiment, the collection chamber 104 is defined as the space existing between the inner plate 120, the lower wall 116, and the walls 106, 108 of the milling chamber 102.

The apparatus 100 also includes hoppers 130a, 130b, 130c that store the unprocessed ingredients (or materials) to be processed by the apparatus 100 during catalyst preparation. The hoppers 130a, b, c are arranged to continuously discharge the unprocessed ingredients into the milling chamber 102, for example, via gravity. Here, the hoppers 130a, b, c are attached to the upper wall 114 of the housing 110, and arranged to dispense unprocessed ingredients contained therein via gravity through the introduction chamber 122 and through the opening 124 (in the inner plate 120) into the milling chamber 102.

In embodiments, the first hopper 130a holds/contains a first unprocessed ingredient (e.g., ASA), the second hopper 130b holds/contains a second unprocessed ingredient (e.g., alumina), and the third hopper 130c holds/contains a third unprocessed ingredient (e.g., metal salt). However, any one or more of the hoppers 130a, b, c may hold/contain other ingredients (whether pre-processed or unprocessed), and/or any one or more of the hoppers 130a, b, c may hold/contain the same ingredient. While the illustrated embodiment depicts three (3) hoppers 130a, b, c, the apparatus 100 may include more or less than three (3) hoppers 130a, b, c. In embodiments, a means may be provided to help move the unprocessed material or to help the unprocessed material to flow from the one or more hoppers 130a, b, c, and such means may be integrated within the one or more hoppers 130a, b, c and/or be provided as a separate piece of equipment. For example, augers or other solid powder flow regulating tools, such as whiskers, may be used to help cause the unprocessed materials to flow from the hopper 130a, b, c. In embodiments, a belt is used to deliver unprocessed material to one or more of the hoppers 130a, b, c. In embodiments, a damper device is utilized to couple any one or more of the hoppers 130a, b, c to the housing 110 to inhibit or otherwise control the amount of vibration imparted on the hopper 130a, b, c.

In the illustrated embodiment, the apparatus 100 further includes guide plates 132a and 132b for helping guide the unprocessed ingredients dispensed by the hoppers 130a, b, c into the milling chamber 102. Here, the guide plates 132a, b are arranged in the introduction chamber 122 and are angled surfaces that extend toward or into the opening 124 in the inner plate 120, so that unprocessed ingredients dispensed from the hoppers 130a, b, c is able to fall to the guide plates 132a, b and then be guided toward and through the opening 124 and into the milling chamber 102, rather than accumulating in the introduction chamber 122.

The apparatus 100 also includes a plurality of grinding balls 140 disposed in the milling chamber 102 and a vibration generating device 142 operable to agitate the grinding balls 140 to thereby mill the unprocessed ingredients received within the milling chamber 102 from the hoppers 130a, b, c. The grinding balls 140 may be made from various types of material including, but not limited to, stainless steel, carbon steel, ceramics, etc. The grinding balls 140 may have various densities, for example, the grinding balls 140 may each have a density of greater than about 2 grams//cm³, or greater than about 3 grams/cm³, and in some embodiments, the grinding balls 140 may each have a density of about 8 grams/cm³. Various numbers of grinding balls 140 may be utilized and, in an example, twenty eight grinding balls 140 may be used.

The grinding balls 140 will be agitated within the milling chamber 120 by operation of the vibration generating device 142, and the grinding balls 140 may be configured to mill/grind the unprocessed (i.e., un-milled or unground) ingredient(s) dispensed into (received within) the milling chamber 102, such that the unprocessed ingredient(s) that has/have been processed in the milling chamber 102 is/are processed (i.e., milled or ground) ingredient(s). Not only is the vibration generating device 142 operable to cause movement (or excite) the grinding balls 140 to thereby mill/grind the unprocessed ingredient and thereby convert the unprocessed ingredient(s) into processed ingredient(s), but the vibration generated by the vibration generating device 142 may also induce/urge movement of any unprocessed ingredient that has fallen onto the guide plates 132a, b towards and through the opening 124 in the inner plate 120, such that the unprocessed ingredient(s) continuously flows into the milling chamber 102.

In the illustrated embodiments, the housing 110 is disposed on top of the vibration generating device 142, with the lower wall 116 being mounted on top of the vibration generating device 142. Here, the vibration generating device 142 is operable to shake portions of the housing 110, within which the milling chamber 102 and the collection chamber 104 are contained, up and down as indicated by arrow 144, or alternatively back and forth, or any combination thereof.

The milling chamber 102 includes one or more openings 146 formed in the sidewalls 106 thereof, with the opening(s) 146 being in communication with the collection chamber 104. Thus, the collection chamber 104 is in communion with the milling chamber 102 through the opening(s) 146. Here, the milling chamber 102 includes a pair of openings 146, but the milling chamber 102 may have more or less than two openings 146. Thus, as the unprocessed ingredients from the hoppers 130a, b, c are continuously deposited in the milling chamber 102, such ingredient(s) will continuously accumulate in the milling chamber 102, where it is processed (i.e., milled or ground) and converted into the processed ingredient(s), until the processed ingredient(s) escapes (or flows out of) the milling chamber 102 through the openings 146, such that the processed ingredient(s) may be continuously discharged from the milling chamber 102 via the openings 146.

The apparatus 100 further includes an outlet 150 in communication with the collection chamber 104. During use, milled ingredients exit the milling chamber 102 via the openings 146 and flow into the collection chamber 104, and such milled ingredients may exit the collection chamber 104 via the outlet 150. In the illustrated embodiment, the collection chamber 104 further includes a guide plate 152 that is provided on a lower side of the collection chamber 104 and oriented to direct the processed ingredients towards the outlet 150. Thus, the guide plate 152 may be sloped toward the outlet 150, such that the slope of guide plate 152 allows the processed ingredients to be gravity fed to the outlet 150. Vibration generated by the vibration generating device 142 may also induce/urge movement of the milled ingredients that have fallen onto the guide plate 152 towards and through the outlet 150, such that the processed ingredients (i.e., the milled and mixed ingredients) continuously flows out of the collection chamber 104.

Thus, during operation of the apparatus 100, an unprocessed ingredient flows out of each of the hoppers 130a, b, c and into the milling chamber 102, as indicated by arrows labeled F. The unprocessed ingredient(s) flow(s) into the introduction chamber 122 and onto the guide plates 132a, b, and the guide plates 132a, b operate as a funnel that directs the unprocessed ingredient(s) through the opening 124 in the inner plate 120 and into the milling chamber 102 (i.e., the guide plates 132a, b funnel the unprocessed ingredient(s) into the opening 124). The hoppers 130a, b, c are operable to continuously discharge or deposit the unprocessed ingredient(s) into the milling chamber 102, such that the unprocessed ingredient(s) accumulate in the milling chamber 102 as they are processed (i.e., ground/milled) into the ground ingredients via agitation of the grinding balls 140. The ingredients/material are ground-up (milled) by the grinding balls 140 when excited by the vibration generating device 142. Further, the milling/grinding performed by the grinding balls 140 and the vibration imparted by the vibration generating device 142 also causes the processed ingredients to be thoroughly mixed together inside of the milling chamber 102.

When the process starts, the discharge rate of processed ingredients from the milling chamber 102 will be relatively low and less than the feed rate at which they are introduced into the milling chamber 102, thereby allowing the materials to accumulate in the milling chamber 102, and steady state will be reached when the amount of ingredients in the milling chamber 102 reaches certain level. At that time, the discharge rate will be the same as the feed rate, and the amount of materials in chamber 102 will maintain constant. Thus, the processed ingredients that have mixed together in the milling chamber 102 will initially accumulate in the milling chamber 102 until there is a sufficient quantity/amount of such material, such that the mixed together processed ingredients exit the milling chamber 102 at a constant rate (approximately equal to the rate of their introduction to the milling chamber 102) via the opening 146 and then flows into the collection chamber 104. In the illustrated embodiment, the mixed together processed ingredients falls from the openings 146 in the milling chamber 102, flows through an annular shaped channel defined between the sidewalls 106 of the milling chamber 102 and the sidewalls 112 of the collection chamber 104, as indicated by arrows labeled F′. The openings 146 and the annular shaped channel together define a discharge channel that guides the processed ingredients into the collection chamber 104 along a flow path, such as that indicated by F′.

The mixed together processed ingredients then land on the guide plate 152, and the guide plate 152 directs such mixed together and processed ingredients towards the outlet 150, through which the mixed together and processed ingredients may exit the apparatus 100 via the outlet 150 for further processing, as indicated by arrow F″. Also, while the mixed together processed ingredients are in the collection chamber 104, they are further mixed together via the vibration/agitation from the vibration generating device 142. The rate at which the apparatus 100 processes the unprocessed ingredients and dispenses them at the outlet 150 (as the mixed together processed ingredients) may be controlled by the rate at which each of the hoppers 130a, b, c dispenses its particular unprocessed ingredients. For example, the hoppers 130a, b, c may all dispense their unprocessed ingredients at the same rate, and overall output of the apparatus 100 may thus be increased or decreased by increasing or decreasing the flow rate permitted by the hoppers 130a, b, c.

Also, the concentration of any particular ingredient in the combined product output by the apparatus 100 at the outlet 150 (i.e., the mixed together and processed ingredients output at the outlet 150) may be adjusted (increased or decreased) by adjusting (increasing or decreasing) the volumetric flow rate of the particular unprocessed ingredient relative to one or more of the other unprocessed ingredients.

Further, the dwell time that the ingredients spend being ground (processed) in the milling chamber 102 may be controlled or varied by the size of the discharge channel. For example, the average milling time that the ingredients are subjected to within the milling chamber 102 may depend on the total area of the discharge channels, as well as other variables including the rate at which the hoppers 130a-c introduce their unprocessed ingredients and the material properties of the milling balls 140 (e.g., their density). The maximum size of the openings 146 is less than the diameter/size of the grinding ball 140 so that the grinding balls 140 are inhibited from exiting the milling chamber 102 (i.e., such that the milling balls 140 remain or are trapped within the milling chamber 102 during use). In embodiments, the ratio of the inner volume of the milling chamber 102 to the area of the openings 146 in the milling chamber 102 should be greater than 1000 to help ensure that the ingredients are subjected to adequate residence time in the milling chamber 102 to thereby ensure good quality milling. The vibration intensity imparted by the vibration generating device 142, as quantified by acceleration or deacceleration rate, may be at least 400 m/s², which is the acceleration due to gravity. The grinding balls 140 may have a density of at least 3 g/cm\hat{ }3 to deliver enough milling intensity and may account for at least 1% of the total inner volume of the milling chamber 102. Further, the density of the material inside the milling chamber 102, defined as the mass of ingredients in the milling chamber 102 plus the mass of the grinding balls 140 within the milling chamber 102, and then dividing that sum by the volume of the milling chamber 102, may be greater than 0.1 g/cc to ensure efficient milling and discharge rate from the milling chamber 102.

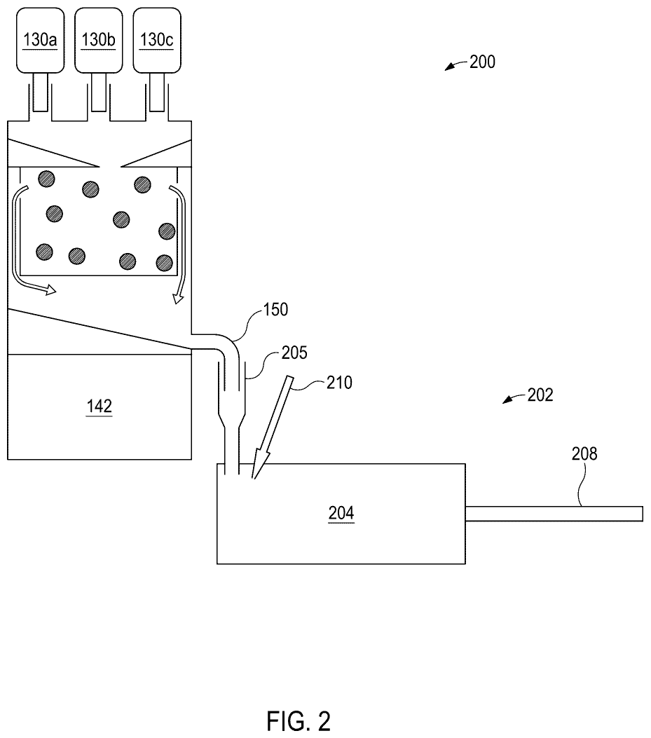

The mixed together processed ingredients that exit the outlet 150 of the apparatus 100 may be subjected to additional processing. For example, the mixed together processed ingredients may be subjected to a kneading and extrusion step, which allows for a continuous extrudate preparation with high quality in minimal time and with a minimal footprint. FIG. 2 depicts a catalyst preparation system 200 utilizing the apparatus 100 of FIG. 1 and incorporating additional kneading and extrusion processing equipment utilized in catalyst preparation, according to one or more embodiments. Thus, FIG. 2 depicts the apparatus 100 of FIG. 1 when connected to additional equipment utilized in catalyst preparation and, more particularly, FIG. 2 depicts a kneader assembly 202 operatively connected to the apparatus 100.

As shown, the kneader assembly 202 (hereinafter, the “kneader 202”) includes a tank 204, an inlet 206 in communication with the tank 204, and an outlet 208 that is also in communication with the tank 204. The inlet 206 is fluidly connected to the outlet 150 of the apparatus 100 when assembled, such that the mixed together processed ingredients that exits the outlet 150 (i.e., final mixture) may enter the tank 204 via the inlet 206.

The kneader 202 also includes a nozzle 210 that is operable for injecting a fluid substance into the tank 204. In embodiments, the fluid substance introduced into the tank 204 via the nozzle is in a liquid state or a gas state. The nozzle 210 may be connected to supply tank (not shown), and the supply tank may be pressurized to push the liquid through the nozzle 210. In another embodiment, the nozzle 210 is a pneumatic nozzle. The substance injected into the tank 204 through the nozzle 210 may include a peptization agent (e.g., a diluted acid solution, such as nitric acid, hydrochloric acid etc.) or water, the latter of which may be utilized to help ensure that the extrusion dough in good shape for extrusion. In embodiments, a metal solution can also be injected into the tank 204 via the nozzle 210, for example, if the manufacturer wants to add the metal into the extrudate before the extrusion. The tank 204 is a kneading chamber where the mixed together processed ingredients may be processed and formed into a dough-like substance or material when mixed with the liquid substance from the nozzle 210. The tank 204 may thus include a means for kneading the processed ingredients, such as counter-rotating gears or blades to achieve the mixing and kneading. Thus, as the mixed together processed ingredients enter the tank 204 via the inlet 206, the nozzle 210 may be utilized to inject the liquid substance that will be mixed with the mixed together processed ingredients in order to form a dough-like substance that may then be extruded out through the outlet 208 to form the catalyst carrier. In embodiments, the liquid material may comprise a peptization agent, water, or a metal solution. In one example, the catalyst preparation system 200 is used for commercial extrudate preparation, such as a hydrocracking catalyst carrier, and in such example the mixed together processed ingredients may be discharged from the assembly 100 to the kneader 202, where it is mixed with the liquid material to generate dough-like substance, and then the dough-like substance is extruded by the outlet 208 attached to the tank 204 as an extruded dough-like substance.

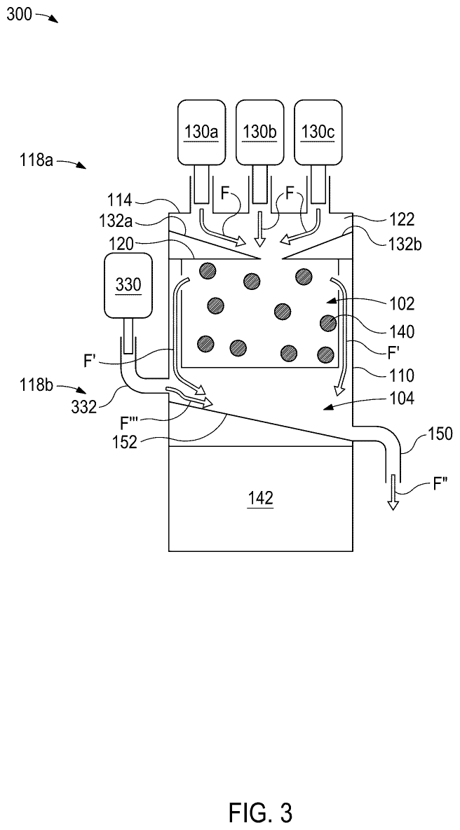

In some end-use applications, certain ingredients utilized in catalyst preparation do not need extensive milling and/or do not need to be milled at all. FIG. 3 depicts an alternate milling and mixing apparatus 300 that is utilizable to prepare catalyst using one or more ingredients that do not need extensive milling, according to one or more embodiments. The milling and mixing apparatus 300 (hereinafter, the “apparatus 300”) is similar to the apparatus 100 detailed above, and thus includes the collection chamber 104 in communication with the outlet 150, the milling chamber 102 positioned within and at least partially above the collection chamber 102, the grinding balls 140 disposed within the milling chamber 102, and the introduction chamber 122 disposed above milling chamber 102. As with the apparatus 100 of FIG. 1, the apparatus 300 of FIG. 3 also includes the hoppers 130a, b, c that are attached to the upper wall 114 of the housing 110 and are each arranged to dispense unprocessed ingredients contained therein via gravity (or conveyance) through the introduction chamber 122 and through the opening 124 (in the inner plate 120) into the milling chamber 102.

In the illustrated embodiment, the apparatus 300 includes at least one additional hopper 330 arranged to continuously discharge an additional unprocessed ingredient into the collection chamber 104. As shown, the additional unprocessed ingredient supplied by the additional hopper 330 is input directly into the collection chamber 104, such that it avoids (bypasses) the milling chamber 102 and thereby avoids interaction with the grinding balls 140 therein. The additional hopper 330 may continuously discharge or deposit its additional ingredient directly into the collection chamber 104, or one or more valves or regulators may be utilized to control or meter output of the additional hopper 330.

Here, the additional hopper 330 is connected to an input tube 332 that extends from the housing 110, and the input tube 332 is arranged to receive the additional unprocessed ingredient of the additional hopper 330 and deposit it within the collection chamber 104. Thus, the input tube 332 that communicates with the interior of the collection chamber 104 such that the additional unprocessed ingredients may flow as indicated by arrow F′″. In some embodiments, the input tube 332 may be positioned on the housing 110 at a location just above the guide plate 152 such that the additional unprocessed ingredient of the additional hopper 330 is deposited on the guide plate 152 as shown by the arrow F′″, after which the additional unprocessed ingredient (which has bypassed/avoided processing in the milling chamber 102) is mixed with the mixed together processed ingredients of the hoppers 130a, b, c that overflows out of the openings 146 in the milling chamber 102, as indicated by the arrow F′. Thereafter, all the additional unprocessed ingredient (from the additional hopper 330) and the mixed together processed ingredients from the hoppers 130a, b, c flow down the guide plate 152, aided by gravity, as a combined flow of ingredients, out of the outlet 150 as indicated by arrow F′″.

In one example, the first hopper 130a holds/contains a first ingredient (e.g., ASA), the second hopper 130b holds/contains a second ingredient (e.g., alumina), the third hopper 130c holds/contains a third ingredient (e.g., metal salt), and the additional hopper 330 holds/contains a different ingredient (e.g., Zeolite) that does not need to be subjected to milling grinding in the milling chamber 102.

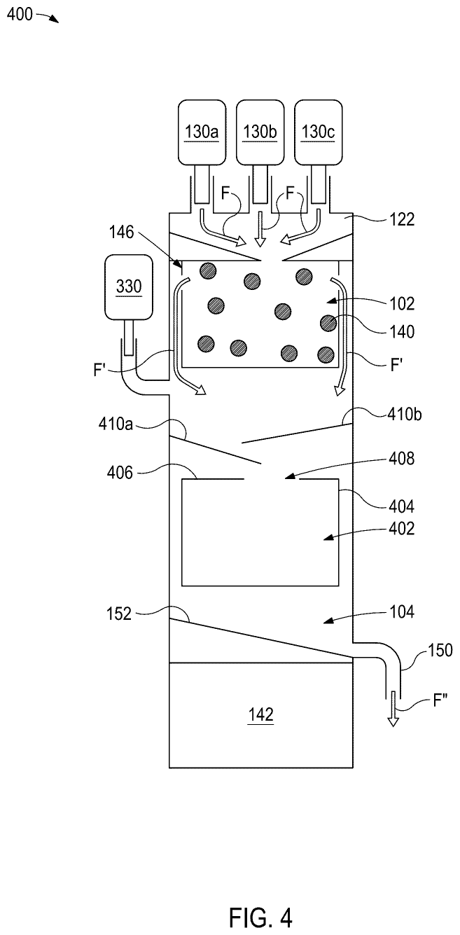

FIG. 4 depicts yet another alternate milling and mixing apparatus 400 that is utilizable to prepare catalyst using one or more ingredients that do not need extensive milling, according to one or more embodiments. The milling and mixing apparatus 400 (hereinafter, the “apparatus 400”) is similar to the apparatuses 100 and 300, detailed above, and thus includes the collection chamber 104 in communication with the outlet 150, the milling chamber 102 positioned within and above the collection chamber 104, the grinding balls 140 disposed within the milling chamber 102, and the introduction chamber 122 disposed above milling chamber 102. As with the apparatus 300, the apparatus 400 of FIG. 4 also includes the additional hopper 330 arranged to continuously discharge the additional unprocessed ingredient into the apparatus 400 and directly into the collection chamber 104, in addition to the hoppers 130a, b, c that introduce their unprocessed ingredients into the milling chamber 102. In this manner, the additional unprocessed ingredient supplied by the additional hopper 330 bypasses the milling chamber 102, as detailed above, so that certain qualities or characteristics of the additional unprocessed ingredient are not adversely impacted by the grinding balls 140, which could adversely impact the final catalyst prepared.

In addition to inclusion of the additional hopper 330, the apparatus 400 further includes a mixing chamber 402. In the illustrated embodiment, the mixing chamber 402 is arranged to continuously receive processed ingredients flowing out of the milling chamber 102, via the openings 146 therein, as well as the additional unprocessed ingredient supplied by the additional hopper 330, wherein the additional unprocessed ingredients supplied by the additional hopper 330 has bypassed the milling chamber 102 by being first introduced into the mixing chamber 402 where it is mixed with the already processed ingredients (that has already been milled and mixed) exiting the milling chamber 102.

As shown, the mixing chamber 402 includes sidewalls 404 and a top wall 406, and an opening 408 formed in the top wall 406 through which the ingredients from the hoppers 130a-c and 330 flows into the mixing chamber 402. Further, the mixing chamber 402 is arranged within the collection chamber 104, such that as the ingredients from the hoppers 130a-c and 330 fills up the mixing chamber 402, such ingredients will overflow and flow out of the mixing chamber 402 through the opening 408 therein, and drip/flow down into the lower portion of the collection chamber 104. In particular, as the mixed together processed ingredients overflow out of the milling chamber 102 and as the additional hopper 330 discharges its additional unprocessed ingredient directly into the collection chamber 104, all of that mixture of processed and unprocessed ingredients continuously flows into the mixing chamber 402 via the opening 406. In the illustrated embodiment, guide plates 410a and 410b are arranged and oriented within the apparatus 400 to direct such mixture of processed and unprocessed ingredients through the opening 406 and into the mixing chamber 402. As the mixture of processed and unprocessed ingredients continuously flow into the mixing chamber 402, those ingredients will be further mixed together within the mixing chamber 402, and the mixing chamber 402 will eventually fill up, such that the mixture of processed and unprocessed ingredients contained therein will eventually overflow and spill over the top wall 406.

The overflowing mixture of processed and unprocessed ingredients will continuously flow out of the mixing chamber 402 via the opening 408 and fall/descend downward within the apparatus 400 and onto the guide plate 152, which directs such mixture of processed and unprocessed ingredients towards and through the outlet 150, as indicated via arrow F′″. By adding/including the mixing chamber 402 to the apparatus 400, the time that the ingredients are mixed together may be extended. Stated differently, the mixing chamber 402 prolongs the amount of time that all the ingredients may all together be subjected to a single mixing process.

In embodiments, grinding media may be provided in the mixing chamber 402. For example, grinding balls similar to the grinding balls 140 may be provided in the mixing chamber 402 and agitated via the vibration generating device 142. However, other types of grinding/milling media may be used in the mixing chamber 402 without departing from the present disclosure. For example, glass balls, Teflon balls, or other media that are less dense/lighter than the grinding balls 140 described above may be utilized.

Also, in other non-illustrated embodiments, a separate vibration generating device may be used to agitate the mixing chamber 402, such that the mixing chamber 402 may be subjected to different intensity agitation than other portions of the apparatus 400 that are agitated via the vibration generating device 142. For example, the mixing chamber 402 may be mounted on the separate vibration generating device such that agitation of the mixing chamber 402 may be separately controlled/adjusted. Here, the user may adjust intensity of agitation of the mixing chamber 402 and separately/independently adjust intensity of agitation imparted by the vibration generating device 142.

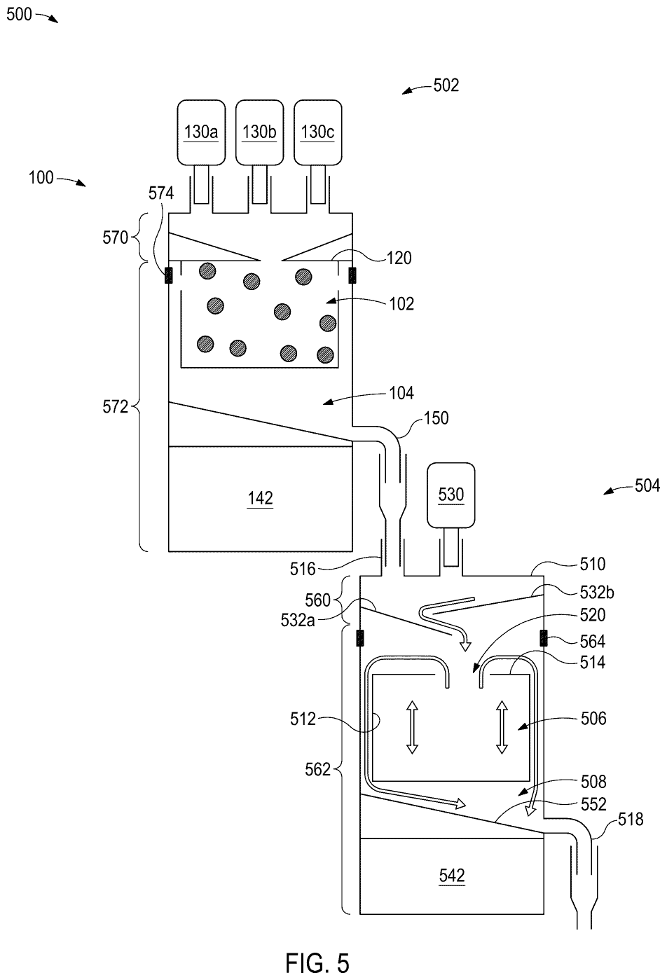

FIG. 5 depicts an exemplary multi-stage milling and mixing system 500, according to one or more embodiments. In the illustrated embodiment, the multi-stage milling and mixing system 500 (hereinafter, “the system 500”) is a two-stage system having a first stage 502 and a second stage 504. In some embodiments, the first stage 502 may comprise the apparatus 100 of FIGS. 1-2, but could alternatively be differently configured, without departing from the present disclosure. In one or more embodiments, for example, the first stage 502 may instead comprise the apparatus 300 of FIG. 3 or the apparatus 400 of FIG. 4, without departing from the present disclosure.

As shown, the second stage 504 includes a mixing chamber 506 that is in communication with the outlet 150 of the first stage 502 for receiving mixed together and processed ingredients from the collection chamber 104 of the first stage 502. In addition, the second stage 504 includes an additional collection chamber 508 positioned to receive mixed together ingredients that continuously overflow from the mixing chamber 506. In particular, the second stage 504 includes a housing 510 within which the mixing chamber 506 and the collection chamber 508 are defined or otherwise provided. Here, the mixing chamber 506 includes sidewalls 512 and a top wall 514 which collectively define the mixing chamber 506, and the mixing chamber 506 may be suspended within the housing 510. Also, the interior of the housing 510 generally defines the collection chamber 508, with the mixing chamber 506 being separated from the collection chamber 508 via the sidewalls 512 and the top wall 514. In addition, the second stage 504 includes an input 516 that is configured to receive the mixed together processed ingredients of the first stage 502 for further processing within the second stage 504 and an output 518 that is configured to discharge processed catalyst. Here, the input 516 is provided on the top of the housing 510 and is fluidly coupled to the outlet 150 of the first stage 502. The output 518 is in communication with the collection chamber 508 so that ingredients that have been suitably mixed in the mixing chamber 506 may exit the second stage 504.

Also in the illustrated embodiment, the second stage 504 further includes at least one additional hopper 530 that stores an additional ingredient that may be different than the ingredients that were input into the system 500 via the first stage 504. The ingredient supplied by the additional hopper 530 may be an additional unprocessed ingredient that is input into the apparatus 100 in a manner that avoids milling/grinding of the additional unprocessed ingredient of the additional hopper 530, similar to how the aforementioned additional hopper 330 inputs its additional unprocessed ingredient directly into the collection chamber 104 of the apparatus 300 or the mixing chamber 402 of the apparatus 400. Here, the additional hopper 530 is arranged on the second stage 504 and, more specifically, the additional hopper 530 is provided on the top of the housing 510, next to the input 516 that is coupled to the first stage 502. In this manner, ingredients input into the second stage 504 from both the first stage 502 and the additional hopper 530 (i.e., mixed together processed material from the first stage 502 and additional unprocessed material from the additional hopper 530) are deposited into the second stage 504 at a top end thereof, which thereby allows gravity to assist in moving/directing such input ingredients down through the second stage 504, as hereinafter described. Inclusion of the additional hopper 530 on the second stage 504 allows the additional unprocessed ingredients contained/housed therein to avoid processing in the first stage 502 that, in the illustrated embodiment, includes milling/grinding. Thus, in the illustrated embodiment, the additional unprocessed ingredient supplied by the additional hopper 530 is deposited directly into the mixing chamber 506 of the second stage 504 and avoids any processing conducted by the first stage 502 that may adversely affect characteristics of the additional unprocessed ingredient, such as its crystallinity.

Also in the illustrated embodiment, the second stage 504 further includes a second vibration generating device 542 (i.e., a second stage agitation device or a second stage vibration device 542) that is operable to agitate ingredients contained within the additional mixing chamber 506. The second vibration generating device 542 may be controlled separately from the vibration generating device 142 of the first stage 502, such that the combination of ingredients acted upon by the second stage 504 are subjected to an agitation intensity that is different that the agitation intensity imparted by the vibration generating device 142 of the first stage 502.

Also in the illustrated embodiment, the second stage 504 further includes guide plates 532a and 532b installed above the mixing chamber 506. Here, the guide plates 532a, b are positioned beneath the input 516 and the additional hopper 530, such that mixed together processed ingredients supplied by the input 516 and additional unprocessed ingredients supplied by the additional hopper 530 together fall (and are together gravity fed) directly onto the guide plates 532a, b. Also, the guide plates 532a, b are positioned above the mixing chamber 506 and oriented/angled towards an opening 520 in the top wall 514 of the mixing chamber 506, such that the guide plates 532a, b continuously direct/guide the ingredients directly into the mixing chamber 506 through the opening 520.

Also in the illustrated embodiment, the collection chamber 508 of the second stage 504 includes a guide plate 552 for directing/guiding the flow of ingredients towards the outlet 518. Here, the guide plate 552 is provided on a lower side of the collection chamber 508 and oriented to direct ingredients that are flowing via gravity towards and through the outlet 518.

During operation, any or all of the ingredients can be continuously input into the second stage 504 via both the input 516 coupled to the first stage 502 and the additional hopper 530. Here, the mixed together processed ingredients supplied from the first stage 502 have been subjected to milling/grinding and have also been at least somewhat mixed in the milling chamber 102 and the collection chamber 104 thereof. That mixed together processed ingredients from the first stage 502 flows downward into the second stage 504 onto the guide plates 132a, b. Similarly, additional unprocessed ingredients supplied from the additional hopper 532, which was not subjected to milling/grinding in order to preserve certain characteristics of the material/ingredient (e.g., its crystallinity), is gravity fed directly into the second stage 504 and flows downward onto the guide plates 132a, b. Then, all the combined ingredients from the first stage 502 and the additional hopper 530 is directed by the guide plates 532a, b, through the opening 520, and into the mixing chamber 506 of the second stage 504.

When all the ingredients from the first stage 502 and the additional hopper 530 are combined in the mixing chamber 506, they may be further mixed and such mixing may be enhanced by vibrating the mixing chamber 506 via the second vibration generating device 542. As the ingredients are continuously deposited into the mixing chamber 506, the mixing chamber 506 will eventually overflow and such mixture of ingredients will flow back out of the mixing chamber 506 (through the opening 520 therein), and then flow downward into the collection chamber 508 and onto the guide plate 552, and the guide plate 552 directs such mixture of ingredients out of the second stage 504 through the outlet 518.

In the illustrated embodiment, the housing 510 of the second stage 504 is a two part housing having a lid portion 560 and a base portion 562. Here, the lid portion 560 may be removably attached to the base portion 562 via an attachment means 564 (e.g., a clamp or a threaded engagement), thereby permitting the user to remove the lid portion 560 when needed to access the interior of the second stage 504. In embodiments, the mixing chamber 506 is connected to the lid portion 560 and is suspended from an interior of the lid portion 560, such that the mixing chamber 506 may be removed from the collection chamber 508 upon removing the lid portion 560, which would thereby expose the collection chamber 508 and the guide plate 552 thereof.

Also in the illustrated embodiment, the first stage 502 is a two part housing having a lid portion 570 and a base portion 572. Here, the inner plate 120 is connected within the lid portion 570, such that the milling chamber 102 of the first stage 502 is suspended from the lid portion 570, thereby allowing the user to remove the milling chamber 102 from the first stage 502 by removing the lid portion 570, which would thereby expose the collection chamber 108 and the guide plate 152. Here, the lid portion 570 may be removably attached to the base portion 572 via an attachment means 574 (e.g., a clamp or a threaded engagement), thereby permitting the user to remove the lid portion 570 when needed to access the interior of the first stage 502.

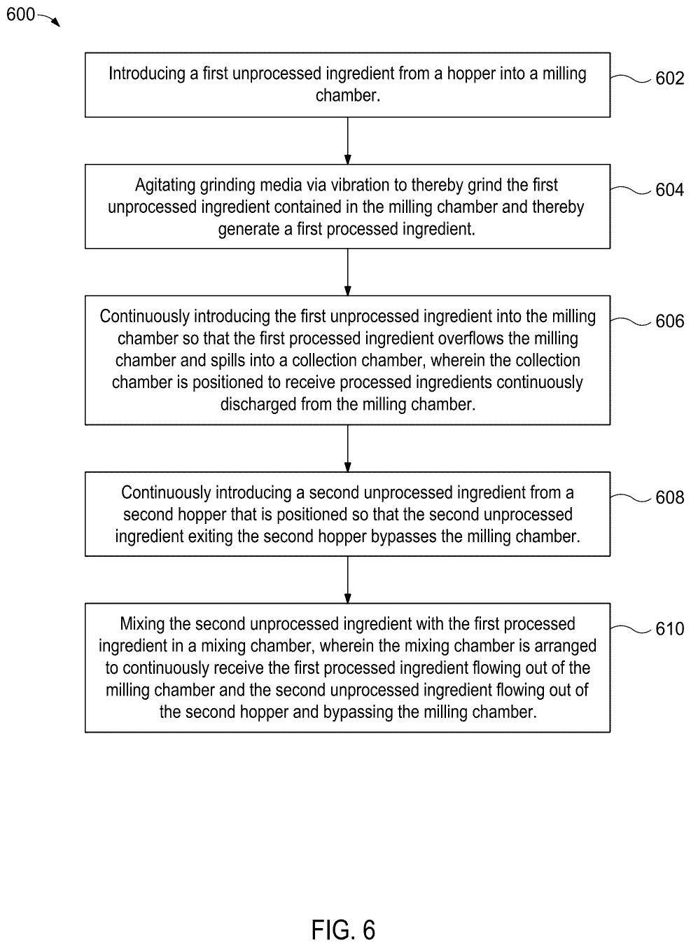

FIG. 6 is a schematic flowchart of an example method 600 for continuously milling and mixing ingredients, according to one or more embodiments. The method 600 may begin at 602 with introducing a first ingredient from a first hopper (e.g., the hoppers 130a-c) into a milling chamber (e.g., the milling chamber 102). The method 600 may continue at 604 with agitating grinding media (e.g., grinding balls 140) via vibration (e.g., via the vibration generating device 142) to thereby grind the first ingredient contained in the miller chamber. The method 600 may continue at 606 with continuously introducing the first ingredient into the milling chamber so that the first ingredient overflows the milling chamber and spills into a collection chamber (e.g., the collection chamber 104), wherein the collection chamber is positioned to receive ingredients continuously discharged from the milling chamber. The method 600 may also continue at 608, with continuously introducing a second ingredient from a second hopper (e.g., the hopper 330 or 530) that is positioned so that the second ingredient exiting the second hopper bypasses the milling chamber. Further, the method 600 may continue at 610, with continuously mixing the second ingredient with the first ingredient in a mixing chamber (e.g., the mixing chamber 402), wherein the mixing chamber is arranged to continuously receive the first ingredient flowing out of the milling chamber and the second ingredient flowing out of the second hopper and bypassing the milling chamber.

Embodiments disclosed herein include:

A. A continuous mixing and milling apparatus, comprising: a milling chamber; one or more hoppers arranged to discharge unprocessed ingredients into the milling chamber; a plurality of grinding balls disposed in the milling chamber; a vibration generating device operable to agitate the grinding balls and thereby grind the unprocessed ingredients received within the milling chamber into processed ingredients; and a collection chamber positioned to receive the processed ingredients discharged from the milling chamber.

B. A continuous mixing and milling apparatus, comprising: a first stage comprising: a first milling chamber; one or more first hoppers arranged to continuously discharge unprocessed ingredients into the milling chamber; a plurality of grinding balls disposed in the milling chamber; a vibration generating device operable to agitate the grinding balls and thereby grind the unprocessed ingredients and generate processed ingredients; a first collection chamber positioned to receive the processed ingredients discharged from the milling chamber; and an outlet in communication with the first collection chamber; and a second stage comprising: a second mixing chamber in communication with the outlet for receiving processed ingredients from the first collection chamber; and a second collection chamber positioned to receive processed ingredients discharged from the second mixing chamber.

C. A method of continuously mixing and milling a plurality of ingredients, comprising: introducing a first unprocessed ingredient from a hopper into a milling chamber; agitating grinding balls via vibration to thereby grind the first unprocessed ingredient within the milling chamber and thereby generate a first processed ingredient; and continuously introducing the first unprocessed ingredient into the milling chamber so that the first processed ingredient overflows the milling chamber and spills into a collection chamber positioned to receive the first processed ingredient overflowing the milling chamber.

Each of embodiments A through C may have one or more of the following additional elements in any combination: Element 1: wherein the milling chamber is disposed within the collection chamber and includes sidewalls and one or more openings defined in the sidewalls to allow the processed ingredients to be continuously discharged from the milling chamber. Element 2: further comprising one or more guide plates arranged above the milling chamber to guide the unprocessed ingredients discharged from the one or more hoppers into the milling chamber. Element 3: an outlet in communication with the collection chamber; and a guide plate provided on a lower side of the collection chamber and oriented to direct the processed ingredients towards the outlet. Element 4: further comprising a kneading chamber in communication with the outlet of the collection chamber for receiving the processed ingredients from the collection chamber. Element 5: wherein the kneading chamber further comprises a nozzle for injecting fluid substance into the processed ingredients contained in the kneading chamber. Element 6: further comprising an additional hopper arranged to discharge a different unprocessed ingredient directly into the collection chamber. Element 7: further comprising a mixing chamber arranged to receive the processed ingredients flowing out of the milling chamber, wherein the collection chamber receives the processed ingredients discharged from the mixing chamber. Element 8: further comprising a plurality of additional grinding balls disposed in the mixing chamber. Element 9: further comprising a housing within which the milling chamber and the collection chamber are at least partially provided, wherein the housing includes a base portion and a lid portion that is removably attachable to the base portion. Element 10: further comprising: an outlet in fluid communication with the collection chamber; a guide plate arranged on a lower side of the collection chamber and oriented to direct the processed ingredients towards the outlet; and a second stage having an additional mixing chamber in communication with the outlet of the collection chamber for receiving processed ingredients from the collection chamber, the second stage including an additional collection chamber positioned to receive processed ingredients discharged from the additional mixing chamber. Element 11: further comprising an additional hopper arranged on the second stage to discharge a different unprocessed ingredient directly into the additional mixing chamber. Element 12: wherein the vibration generating device comprises a first vibration generating device, and the second stage includes a second vibration generating device operable to agitate processed ingredients contained within the additional mixing chamber. Element 13: wherein the second stage agitation device further includes one or more guide plates arranged above the additional mixing chamber to guide processed ingredients into the additional mixing chamber. Element 14: wherein the outlet comprises a first outlet and the guide plate comprises a first guide plate, the second stage agitation device further including: a second outlet in communication with the additional collection chamber; and a second guide plate arranged on a lower side of the additional collection chamber and oriented to direct processed ingredients towards the second outlet.

Element 15: wherein the hopper comprises a first hopper and the method further comprises continuously introducing a second unprocessed ingredient from a second hopper into the collection chamber, the second hopper being positioned so that the second unprocessed ingredient bypasses the milling chamber. Element 16: further comprising mixing the second unprocessed ingredient with the first processed ingredient in a mixing chamber arranged to continuously receive the first processed ingredient from the milling chamber and the second unprocessed ingredient bypassing the milling chamber from the second hopper.

By way of non-limiting example, exemplary combinations applicable to A through C include: Embodiment A with Element 4; Embodiment A with Elements 4-5; Embodiment A with Elements 4-6; Embodiment A with Element 7; Embodiment A with Elements 7-8; Embodiment A with Element 10; Embodiment A with Elements 10-11; Embodiment A with Element 10 and Element 11; Embodiment A with Element 10 and Element 12; Embodiment A with Element 10 and Element 13; Embodiment A with Element 10 and Element 14; Embodiment C with Element 15; and Embodiment C with Elements 15-16.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second. ” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A continuous mixing and milling apparatus, comprising:
a milling chamber;
one or more hoppers arranged to discharge unprocessed ingredients into the milling chamber;
a plurality of grinding balls disposed in the milling chamber;
a vibration generating device operable to agitate the grinding balls and thereby grind the unprocessed ingredients received within the milling chamber into processed ingredients; and
a collection chamber positioned to receive the processed ingredients discharged from the milling chamber.

2. The continuous mixing and milling apparatus of claim 1, wherein the milling chamber is disposed within the collection chamber and includes sidewalls and one or more openings defined in the sidewalls to allow the processed ingredients to be continuously discharged from the milling chamber.

3. The continuous mixing and milling apparatus of claim 1, further comprising one or more guide plates arranged above the milling chamber to guide the unprocessed ingredients discharged from the one or more hoppers into the milling chamber.

4. The continuous mixing and milling apparatus of claim 1, further comprising:
an outlet in communication with the collection chamber; and
a guide plate provided on a lower side of the collection chamber and oriented to direct the processed ingredients towards the outlet.

5. The continuous mixing and milling apparatus of claim 4, further comprising a kneading chamber in communication with the outlet of the collection chamber for receiving the processed ingredients from the collection chamber.

6. The continuous mixing and milling apparatus of claim 5, wherein the kneading chamber further comprises a nozzle for injecting fluid substance into the processed ingredients contained in the kneading chamber.

7. The continuous mixing and milling apparatus of claim 1, further comprising an additional hopper arranged to discharge a different unprocessed ingredient directly into the collection chamber.

8. The continuous mixing and milling apparatus of claim 1, further comprising a mixing chamber arranged to receive the processed ingredients flowing out of the milling chamber, wherein the collection chamber receives the processed ingredients discharged from the mixing chamber.

9. The continuous mixing and milling apparatus of claim 8, further comprising a plurality of additional grinding balls disposed in the mixing chamber.

10. The continuous mixing and milling apparatus of claim 1, further comprising a housing within which the milling chamber and the collection chamber are at least partially provided, wherein the housing includes a base portion and a lid portion that is removably attachable to the base portion.

11. The continuous mixing and milling apparatus of claim 1, further comprising:
an outlet in fluid communication with the collection chamber;
a guide plate arranged on a lower side of the collection chamber and oriented to direct the processed ingredients towards the outlet; and
a second stage having an additional mixing chamber in communication with the outlet of the collection chamber for receiving processed ingredients from the collection chamber, the second stage including an additional collection chamber positioned to receive processed ingredients discharged from the additional mixing chamber.

12. The continuous mixing and milling apparatus of claim 11, further comprising an additional hopper arranged on the second stage to discharge a different unprocessed ingredient directly into the additional mixing chamber.

13. The continuous mixing and milling apparatus of claim 11, wherein the vibration generating device comprises a first vibration generating device, and the second stage includes a second vibration generating device operable to agitate processed ingredients contained within the additional mixing chamber.

14. The continuous mixing and milling apparatus of claim 11, wherein the second stage agitation device further includes one or more guide plates arranged above the additional mixing chamber to guide processed ingredients into the additional mixing chamber.

15. The continuous mixing and milling apparatus of claim 11, wherein the outlet comprises a first outlet and the guide plate comprises a first guide plate, the second stage agitation device further including:
a second outlet in communication with the additional collection chamber; and
a second guide plate arranged on a lower side of the additional collection chamber and oriented to direct processed ingredients towards the second outlet.

16. A continuous mixing and milling apparatus, comprising:
a first stage comprising:
a first milling chamber;
one or more first hoppers arranged to continuously discharge unprocessed ingredients into the milling chamber;
a plurality of grinding balls disposed in the milling chamber;
a vibration generating device operable to agitate the grinding balls and thereby grind the unprocessed ingredients and generate processed ingredients;
a first collection chamber positioned to receive the processed ingredients discharged from the milling chamber; and
an outlet in communication with the first collection chamber; and
a second stage comprising:
a second mixing chamber in communication with the outlet for receiving processed ingredients from the first collection chamber; and
a second collection chamber positioned to receive processed ingredients discharged from the second mixing chamber.

17. The continuous mixing and milling apparatus of claim 16, further comprising at least one additional hopper arranged on the second stage to discharge a different unprocessed ingredient directly into the second mixing chamber.

18. A method of continuously mixing and milling a plurality of ingredients, comprising:
introducing a first unprocessed ingredient from a hopper into a milling chamber;
agitating grinding balls via vibration to thereby grind the first unprocessed ingredient within the milling chamber and thereby generate a first processed ingredient; and
continuously introducing the first unprocessed ingredient into the milling chamber so that the first processed ingredient overflows the milling chamber and spills into a collection chamber positioned to receive the first processed ingredient overflowing the milling chamber.

19. The method of claim 18, wherein the hopper comprises a first hopper and the method further comprises continuously introducing a second unprocessed ingredient from a second hopper into the collection chamber, the second hopper being positioned so that the second unprocessed ingredient bypasses the milling chamber.

20. The method of claim 19, further comprising mixing the second unprocessed ingredient with the first processed ingredient in a mixing chamber arranged to continuously receive the first processed ingredient from the milling chamber and the second unprocessed ingredient bypassing the milling chamber from the second hopper.
